(19) United States
(12) Patent Application Publication
(10) Pub. No.: US 2024/0140710 A1
(43) Pub. Date: May 2, 2024

(54) TRANSPORTATION ASSEMBLIES PROVIDING A PUZZLE BASED STORAGE SYSTEM

(71) Applicant: WHEEL.ME AS, Oslo (NO)

(72) Inventor: Atle TIMENES, Snarøya (NO)

(21) Appl. No.: 18/278,690

(22) PCT Filed: Feb. 17, 2022
(86) PCT No.: PCT/EP2022/053972

§ 371 Date: Aug. 24, 2023

(30) Foreign Application Priority Data
Feb. 26, 2021 (NO) 20210270
Oct. 27, 2021 (NO) 20211286

(51) Int. Cl. B65G 1/137; B65G 1/04; B65G 1/06

(52) U.S. Cl. CPC B65G 1/1371; B65G 1/0478; B65G 1/065; B65G 7/04

(57) ABSTRACT

A puzzle-based storage system to be operated on a floor area, and a method for providing such, comprising a set of separate transportation assemblies placed together in a two-dimensional puzzle-based configuration occupying minimal floor area. Each transportation assembly comprises a rolling arrangement connected to a transportation body for moving the transportation assembly on the floor area, each transportation assembly is carrying and conveying a storage device. The rolling arrangement connected to each transportation body comprises at least four replaceable autonomous rolling devices, where each rolling device comprises a rolling element, driving means, sensors, controller, communication means, and a rechargeable power supply. Charging means providing power to the rechargeable power supply is provided on the floor area where the puzzle-based storage system is operating. Positions of each transportation assembly is controlled by a central controller unit comprising transmitting and receiving means and which is wirelessly connected to at least one of the replaceable autonomous rolling devices of each transportation assembly.

### TECHNICAL FIELD

The present invention relates to a conveyance system and method, and more specifically to a mobile puzzle-based system suitable for supporting and moving objects to requested positions on a floor area while occupying minimal floorspace.

### BACKGROUND

Storing goods require allocation of space. Real estate is a limited commodity and real estate prices are increasing in areas closer to the cities where people live. At the same time companies wish to reduce lead times, especially in online retailing. Higher costs associated with required area for storage combined with rapid retrieval pose a challenge, especially for small and medium sized stores. Usually, inventory management is a trade-off between compact storage and accessibility of goods.

Another aspect is that order picking activities are very labour intensive. Order picking typically represents 55% of all operating costs in a typical warehouse. This has motivated use of different kinds of automated picking systems. An example of this is a picking system where inventory is handled by robots and brought to a picker at a picking station instead of a picker using much time on transportation between shelves for picking inventory, which is more time-consuming.

Today there are different largescale storage systems where storage containers are stacked and stored in columns in a grid structure. Storage containers are picked and handled by robots, running on top of the grid structure, and delivered to a picking station. Such systems are expensive and suited for large scale storage.

There are also storage systems intended for smaller scale storage, typically where a storage area is limited. Example of such systems are robotic mobile fulfilment systems and puzzle-based storage systems based on mobile platforms transporting items. Puzzle-based storage systems are inspired by the famous game 15-puzzle where the objective is to arrange 15 numbered tiles in a 4×4 grid in sequence with only one empty slot allowing adjacent tiles to the empty slot to slide.

WO 03/068657 A2 describes an example of a puzzle-based storage system based on moving platforms for handling payloads such as palletized and containerized items. Each platform comprises several complex mechanical parts, and where each platform is guided on a floor by roller guides mounted on the platform or the floor.

Movements and guiding of a platform are enabled by a set of guide rollers and drive gears mounted on two edges and a set of guideways and racks on the other edges. Each platform comprises several complex mechanical parts.

WO 9831579 A1 describes an example of a robotic system with moving platforms running on tracks. Each platform, called pallet, is equipped with a first set of wheels adapted to travel in a first direction and a second set of wheels adapted to travel in a second direction perpendicular to the first direction. In this solution tracks are installed in the area where pallets are operating, and the pallets cannot move outside tracks.

Prior art puzzle-based storage systems for conveying storage devices on a floor area are complex and typically require a fixed framework installation to be installed for guiding a moving platform conveying containers or similar. If a moving platform is broken, the whole platform must be replaced. It is further cumbersome to reconfigure a system by for instance expanding it with more moving platforms.

The present invention alleviates the drawbacks of prior art systems by providing a more flexible and cost-effective solution for carrying, storing, and conveying objects and transportation assemblies. The system can be operated without having to pre-install a frame structure, grids, or markings where moving platforms are restricted to operate.

Each transportation assembly comprises autonomous rolling devices that can easily be replaced if needed, e.g. in case of a malfunctioning rolling device or upgrading to a newer version with new features. It is further easy to reconfigure a specific puzzle-based configuration, i.e. by adding or removing separate transportation assemblies without having to add or remove other corresponding infrastructure such as physical tracks or markings. This makes the system cost effective and flexible and well suited for small and medium sized storage facilities.

### SUMMARY OF THE INVENTION

The invention is defined by a puzzle-based storage system to be operated on a floor area, comprising a set of separate transportation assemblies placed together in a two-dimensional puzzle-based configuration occupying minimal floor area.

Each transportation assembly comprises a rolling arrangement connected to a transportation body for moving the transportation assembly on the floor area, and each transportation assembly is carrying and conveying a storage device.

The rolling arrangement comprises at least four replaceable autonomous rolling devices. Each rolling device comprises a rolling element, driving means, sensors, controller, communication means, and a rechargeable power supply.

Charging means for providing power to the rechargeable power supply is provided on the floor area where the puzzle-based storage system is operating.

Positions of each transportation assembly, within the floor area the puzzle-based storage system is operating, is controlled by a central controller unit comprising transmitting and receiving means. The central controller is wirelessly connected to at least one of the replaceable autonomous rolling devices.

According to one embodiment of the invention, interface elements are mounted to each transportation body and adapted for receiving and connecting each rolling device to the transportation body. The interface elements may comprise a click-on pull-out mechanism for securing the rolling devices to the transportation assembly while it is easy to replace rolling devices.

According to one embodiment, the storage device carried by each transportation assembly is one or more containers, shelf-systems, or a combination of these. The hight of the different storage devices may differ and can be changed according to needs.

According to one embodiment, a storage device is a rotating shelf system enabling access to all shelfs at a floor level.

According to one embodiment, the transportation assembly comprises connection means for securing the storage device to the transportation body. This will position and hold the storage devices secure to the transportation assemblies.

According to one embodiment, a control device is connected to the central controller. The control device is a device that can receive input from an operator. An operator may for instance request a specific product, and the transportation assembly with the storage device containing the product will be made accessible by rearranging the transportation assemblies in the puzzle-based storage system. The re-arranging operation is controlled by the central controller.

According to one embodiment of the invention, one of the autonomous rolling devices connected to a transportation body of a transportation assembly is operating as a master device and is wirelessly connected to the other autonomous rolling devices connected to same transportation body. In this embodiment, the central controller is transmitting control instructions to the master device, while the other autonomous rolling devices connected to same transportation body will receive control instructions from the master device.

According to one embodiment, the charging means on the floor area where the puzzle-based storage system is operating is charging tracks placed at positions below a footprint of the autonomous rolling devices.

According to one embodiment, the charging means on the floor area where the puzzle-based storage system is operating is an inductive charging device placed below a footprint of each autonomous rolling devices of one or more transportation assemblies in the set of transportation assemblies.

According to another embodiment, the inductive charging device is placed below a footprint of each autonomous rolling devices of two or more transportation assemblies in the set of transportation assemblies.

According to one embodiment, the inductive charging device is a charging mat with individually controllable inductive charging zones for each autonomous rolling device of one or more transportation assemblies. In this embodiment, autonomous rolling devices operating as master devices may receive more charging power than the others. The charging power can also be adjusted according to current charging level of each the autonomous rolling device.

According to one embodiment, each inductive charging zone comprises an NFC device. This will help to provide easy detection and positioning of autonomous rolling devices.

For placing items in and picking items from storage devices the system may, according to an embodiment, further comprise an automated picking system.

In one embodiment, the automated picking system is placed within the same area that the puzzle-based storage system is operating. It may for instance be a transportation assembly a storage device is replaced with a picking system, such as a robot. In this embodiment, the transportation assembly with the picking system may pick a specified item or items and leave the puzzle-based configuration and convey the picked item(s) to a specified destination.

According to another embodiment, the automated picking system is placed on the outside of the floor area where the puzzle-based storage system is operating. This may for instance be an automated picking system operating within reach of storage devices conveyed by transportation assemblies located next to the puzzle-based configuration.

For keeping track of current positions of each transportation assembly, one embodiment of the puzzle-based storage system comprises one or more cameras connected to the central controller for determining positions of each transportation assembly based on visual input.

In one embodiment, the one or more cameras are connected on top of each storage device and directed to a ceiling above the puzzle-based storage system for detecting patterns in the ceiling. The ceiling may be painted or covered with a specific recognizable pattern which is used for guidance of positions. A specific pattern may also be projected on the ceiling above the puzzle-based storage system.

In one embodiment, the one or more cameras are connected to the ceiling and directed at the storage devices for detecting identifications provided on the storage devices.

The invention is further defined by a method for providing a puzzle-based storage system to be operated on a floor area, by providing a set of transportation assemblies and placing the transportation assemblies together in a two-dimensional puzzle-based configuration to occupy minimal floor area, where each transportation assembly is provided by connecting a rolling arrangement to a transportation body of the transportation assembly for enabling moving the transportation assembly on the floor area, and installing a storage device on each transportation assembly.

The method further comprises the steps of providing autonomy to each transportation assembly by using at least four replaceable autonomous rolling devices as the rolling arrangement, where each replaceable autonomous rolling device comprises a rolling element, driving means, sensors, controller, communication means, and a rechargeable power supply;
providing charging means on the floor area where the puzzle-based storage system is operating for providing charging power to the rechargeable power supply;
providing a central controller unit with transmitting and receiving means and with a computer program product for controlling movements of each transportation assembly by transmitting control commands to at least one of the replaceable autonomous rolling devices according to received input instructions;
arranging and re-arranging positions of each transportation assembly in the set of transportation assemblies according to position information of each transportation body stored in a database connected to the central controller unit and control commands transmitted to the rolling devices.

The present invention is further defined by a computer program product that when executed on a central controller unit controls movements of autonomously operating rolling devices connected to transportation bodies, together making transportation assemblies of a storage system, the transportation assemblies are arranged as a set of transportation assemblies in a two-dimensional compact puzzle-based configuration, and where movements of the rolling devices are controlled by the computer program according to position information stored in a database and input commands received from a control device.

### BRIEF DESCRIPTION OF THE DRAWINGS

The invention will be described in more detail by reference to the accompanying figures showing examples of embodiments within the claimed scope of protection.

FIG. 1 illustrates an example of a puzzle-based storage system with storage devices placed on transportation assemblies.

FIG. 2 illustrates a two-dimensional 4×4 puzzle-based configuration with a set of transportation assemblies and connection means for securing storage devices to the transportation body.

FIG. 3 illustrates an example of a transportation body comprised in a transportation assembly.

FIG. 4 illustrates an example of an embodiment where charging tracks are used as the charging means.

FIG. 5 illustrates an example of placements of charging tracks relative to an autonomous rolling device 40.

FIG. 6 illustrates charging pins extending from the body of an autonomous rolling device to be in contact with charging tracks.

FIG. 7 illustrates an example of an embodiment where the charging means is a charging mat with inductive charging zones in positions adapted for charging the autonomous rolling devices.

FIG. 8 illustrates a two-dimensional 3×3 puzzle-based configuration with a set of transportation assemblies operating on a charging mat.

FIG. 9 illustrates an example of an automated picking system where a robot is connected to a transportation assembly for picking and placing items in the storage devices.

FIG. 10 illustrates communication between autonomous rolling devices of a transportation assembly and a central controller unit.

FIG. 11 illustrates communication between an autonomous rolling device, operating as a master device of a transportation assembly, and a central controller unit as well as communication between the master device and other autonomous rolling devices connected to same transportation assembly.

### DETAILED DESCRIPTION

The present invention concerns a puzzle-based storage system handling storage devices occupying minimal floor area.

The storage system is made by providing a set of transportation assemblies, where each transportation assembly is adapted for carrying and conveying a storage device. Each transportation assembly is provided with a unique ID and the set of transportation assemblies and arranged together in a two-dimensional compact puzzle-based configuration and provided with at least four autonomously driven rolling devices connected to a transportation body. Each autonomously rolling device is given a unique ID and is linked the transportation assembly it is connected to. In this way, all the transportation assemblies are individually controlled by transmitting unique movement instructions to corresponding autonomous rolling devices as well as transmitting individual status information from the autonomous rolling devices.

Controlling of the autonomous rolling devices is performed by a central controller unit transmitting control commands to the autonomous rolling devices for moving and rearranging positions of each transportation assembly within the puzzle-based storage system.

Rearranging of transportation assemblies is initiated by requesting a specific storage device carried by a transportation assembly to be accessible at a specific delivery point. The specific storage device is linked to a requested object or item stored in the storage device. An algorithm in a central controller unit is configured to provide an optimal route for the transportation assembly conveying the requested storage device through the puzzle-based configuration to reach the delivery point. The algorithm may define pattern to follow according to a current position of a requested storage device.

The delivery point may be an accessible area or position at the border of the puzzle-based configuration where it can be picked up, or it may be a specific location outside of the puzzle-based configuration. In this case, a transportation assembly with the requested storage device will leave the puzzle-based configuration and drive to a requested location.

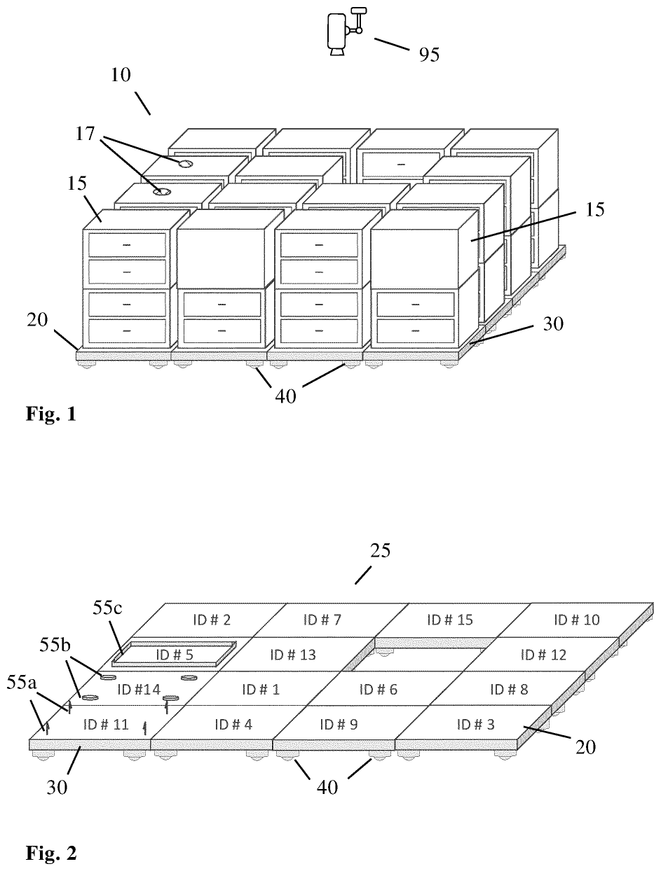

FIG. 1 illustrates an example of a puzzle-based storage system 10 with storage devices 15 connected to transportation assemblies 20 that are arranged together in a two-dimensional compact puzzle-based configuration making a set of transportation assemblies 20. By placing and keeping transportation assemblies 20 close together as shown in this example, minimal floorspace is occupied.

Storage devices 15 placed on transportation assemblies 20 can be any type of storage devices for holding and storing items. Examples of such are containers, drawer systems and shelf-systems. These can be combined such that for instance a storage device 15 placed on a transportation assembly 20 is a combination of a container- and drawer-system as illustrated in FIG. 1.

If a storage device in a transportation assembly comprises drawers, each drawer may be tagged or marked with an ID such that a picking robot can identify in which drawer a requested product is stored.

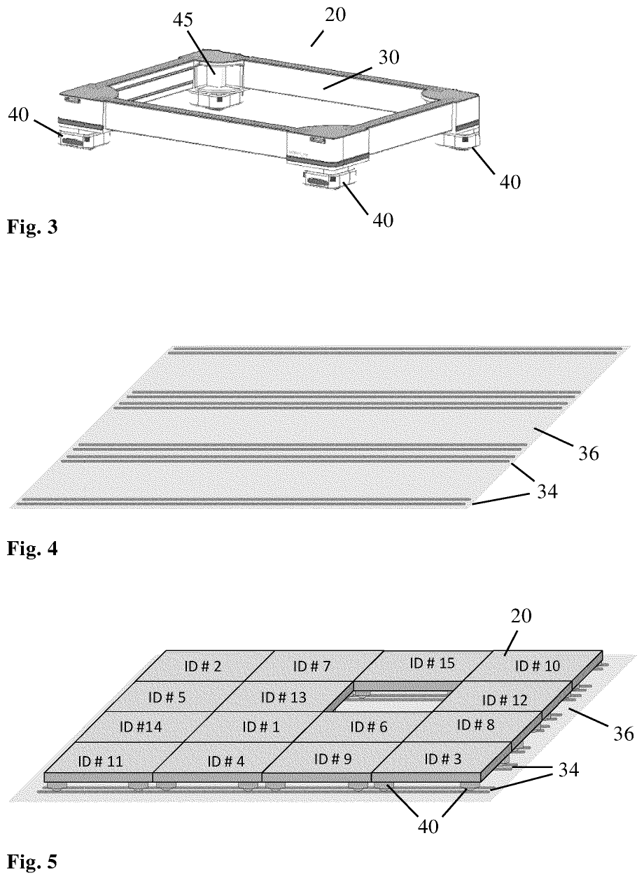

Each transportation assembly 20 comprises a rolling arrangement connected to a transportation body 30. An example of a transportation body 30 is illustrated in FIG. 3 showing a frame structure where replaceable autonomous rolling devices 40 are connected to the frame structure for providing the rolling arrangement.

FIG. 1 further shows a camera 95 directed at the storage devices 15. The camera can identify positions of the storage devices 15 in the puzzle-based storage system. For easy identification different markings 17 can be attached to the storage devices 15 and the different marking are linked to the ID of storage devices.

FIG. 2 shows a two-dimensional puzzle-based configuration with a set 25 of transportation assemblies 20. The figure illustrates more clearly how the transportation assemblies 20 can be placed close together in the two-dimensional configuration. As seen from the figure, one transportation assembly 20 is missing, i.e. one slot is empty. This makes it possible to rearrange each transportation assembly 20 in the set 25 of transportation assemblies 20 to all positions within the two-dimensional configuration. This is known as a puzzle-based configuration.

The puzzle-based configuration illustrated in the figure has 15 numbered transportation assemblies 20 in a 4×4 grid where one slot is empty allowing transportation assemblies 20 adjacent to the empty slot to slide into the empty slot. The goal is to arrange the numbered transportation assemblies 20 according to a sequence defining which transportation assembly 20 to move into an empty slot and in which order. How different sequences are established are well known from prior art puzzle-based systems and are not described further here.

Removing more than one transportation assembly 20 from the puzzle-based configuration, enables moving and rearranging more than one transportation assembly 20 at a time, thereby requiring fewer rearranging steps for the transportation assemblies 20, resulting in faster access to a requested storage device 15. This may be advantageous for larger puzzle-based configurations comprising the autonomous transportation assemblies 20. Removing two or more transportation assemblies 20 carrying storage devices from the puzzle-based configuration will provide space for a transportation assembly 20 carrying a dedicated picking robot.

Removing two or more transportation assemblies 20 from the puzzle-based configuration will give less iteration steps for a requested transportation assembly to go from its current position to a requested position.

By allocating a lager floor area for the puzzle-based storage system than the footprint of the set 15 of separate transportation assemblies 20 making the puzzle-based storage system 10, other movement patterns of the transportation assemblies 20 can be performed, e.g. two or more transportation assemblies 20 can be moved as a group at the same time thereby providing a shorter route for a requested transportation assembly 20.

Storage devices 15, as well as other devices such as picking robots, are preferably secured to the transportation assemblies 20 by connection means. The connection means can be any type of mechanism securing a storage device 15 in a fixed position on a transportation assembly 20. As an example, grippers 55a are mounted to a transportation assembly 20 for providing secure connection of a storage device 15 to the transportation assembly 20 and for holding storage devices 15 in fixed positions on the transportation assemblies 20. Other examples of connections and holding means are screws, magnets 55b, a frame 55c or a combination of these.

According to the invention, a transportation assembly 20 comprises a transportation body 30 and at least four autonomous rolling devices 40 connected to the transportation body 30. Each rolling device 40 is autonomously controlled.

FIG. 3 shows an example of a transportation body 30 of a transportation assembly 20, where autonomous rolling devices 40 are connected to interface elements 45 at each corner of a rectangular shaped transportation body 30. By connecting the autonomous rolling devices 40 to each corner of the transportation body 30, the transportation assembly 20 can move autonomously by itself independently of external means transporting the transportation assembly 20, and without a transportation assembly 20 comprising complex mechanical parts and driving means. The interface elements 45 are adapted for connecting and disconnecting each autonomous rolling device 40 to the transportation bodies 30. The interface elements 45 can for instance be a click-on pull-out type for easy replacement of rolling devices 40 if necessary.

The figure shows four autonomous rolling devices 40 connected to a transportation body. Different configurations are however feasible, e.g. six or eight connected autonomous rolling devices 40. More than four autonomous rolling device 40 can be used for handling heavier loads and larger transportation bodies 30.

More details of the transportation bodies 30 and interface elements 45 are described in applicant's own patent application NO 20201025, which is hereby included as a reference.

Charging of the autonomous rolling devices 40 is a key feature for continuous operation of the puzzle-based storage system 10.

FIG. 4 shows an example of an embodiment providing power to the rechargeable power supply comprised in the autonomous rolling devices 40. In this embodiment, tracks 34 are used to provide power to charging means. Tracks 34 can be placed directly on a floor 36, or they can be integrated in mats connected to each other. The figure shows pairs of tracks 34 that are placed on the floor area where the puzzle-based storage system is to be operated. Each track is connected to a power supply, and a pair of tracks provides direct current (DC) charging power for the rechargeable power supply. The figure shows tracks covering the floor area where the transportation assemblies 20 are operating. In this way all autonomous rolling devices 40 can be charged at det same time and at all possible positions within the floor area they are operating on. It is however sufficient to only have a pair of tracks on a floor area covering only one transportation assembly 20. For such solution, all transportation assemblies 20 need to stay at the positions where the tracks are, one at a time for being charged.

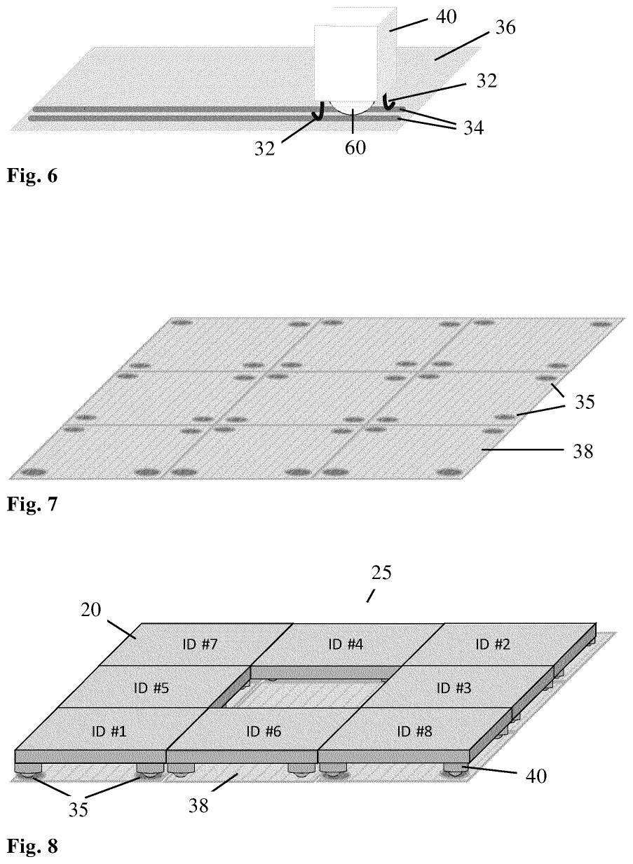

FIG. 5 illustrates an example of placements of charging tracks 34 relative to autonomous rolling devices 40 of transportation assemblies 20. In this embodiment, each autonomous rolling device 40 is provided with a pair of charging pins 32, as illustrated in FIG. 6.

FIG. 6 illustrates an example where charging pins 32 extend from the body of an autonomous rolling device 40 to be in contact with charging tracks. The charging pins 32 are connected to respective positive and negative poles of a charging device comprised in the autonomous rolling device 40 for charging the rechargeable power supply. A charging pin 32 is placed on each side of the rolling element 60 of the autonomous rolling device 40 and is in contact with respective positive and negative current-carrying tracks when the charging the autonomous rolling devices 40.

Power supplied to the tracks 34 can be controlled by switching the power source on or off, or by controlling how much power each pair of tracks is carrying at any time.

In one embodiment, when tracks are used for providing charging power, the autonomous rolling devices 40 comprise a lifting- and lowering mechanism for lifting and lowering the rolling element 60, thereby connecting and disconnecting charging pins 32 to and from the tracks 34. When a transportation body 30 is being moved, all autonomous rolling devices 40 are in an upper position and the charging pins 34 are disconnected from the tracks 34. When being charged, the autonomous rolling devices 40 are in a lower position, such that the charging pins 32 are connected to the tracks 34.

In another embodiment, the charging pins 32 are extendable and retractable while the rolling element 60 is in a fixed position. When being charged, the charging pins 32 are extended from the autonomous rolling device 40 to connect to the tracks 34. When a transportation body 30 is being moved, all charging pins 32 of its connected rolling devices 40 are in retracted position, thereby disconnecting the charging pins 34 from the tracks 34.

FIG. 7 illustrates another example of charging means. In this example, a charging mat 38 with inductive charging zones 35 placed at positions provides charging power for the autonomous rolling devices 40, e.g. at positions directly below the autonomous rolling devices 40 when they are stationary. The example shows inductive charging zones for each autonomous rolling devices 40. This may however not be necessary, since only one charging mat 38 with inductive charging zones 35 is sufficient for charging all autonomous rolling devices 40 of a transportation assembly 20. This will probably result in a charging queue since only one transportation assembly 20 will be charged at a time. More charging mats 38 or a larger charging mat with more charging zones will reduce charging time for all transportation assemblies 20.

When having several charging zones for providing power to the rechargeable power supply of the autonomous rolling devices, each inductive charging zone 35 can be individually controlled to provide power adapted and adjusted according to current charging level and requirements of each the autonomous rolling device 40. A master device may for instance comprise a rechargeable battery having larger capacity than other devices, for providing sufficient power to connected electronics and sensors, and thus requires more charging power.

FIG. 8 shows a two-dimensional 3×3 puzzle-based configuration with a set of transportation assemblies operating on a charging mat 38. This is a smaller configuration than the example illustrated in FIGS. 1 and 2. Smaller puzzle-based storage systems will be suitable for private use in houses and flats. The FIG. further illustrates an example where the charging means are wireless, and where charging is performed when a wheel is positioned on a marked spot. A charging mat 38 is placed on a floor area where the puzzle-based storage system is operating. The charging mat 38 is provided with charging means 35 for charging the autonomous rolling devices 40.

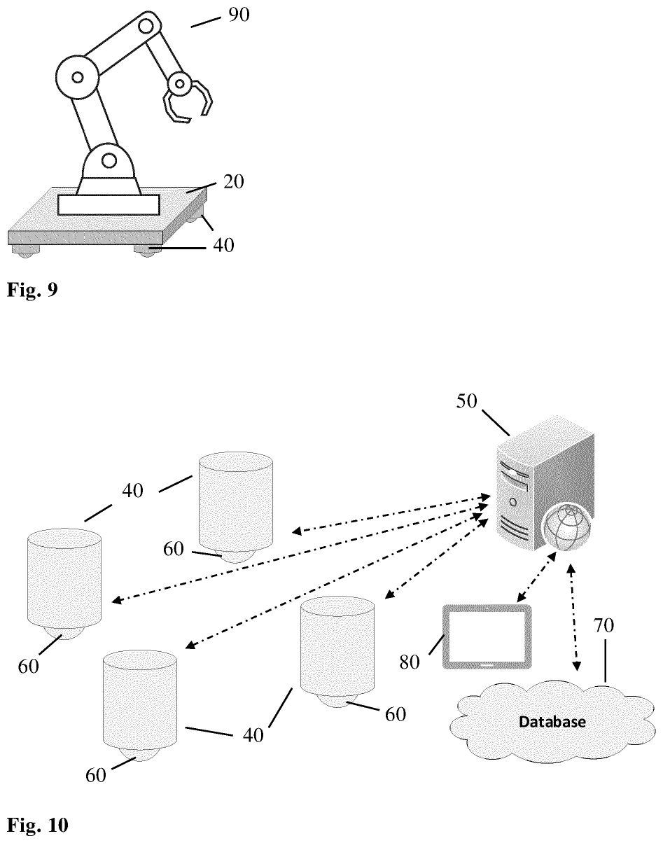

FIG. 9 illustrates an example of an automated picking system where a robot 90 is connected to a transportation assembly 20 for picking and placing items in storage devices 15. The transportation assembly 20 with the robot 90 can operate within or outside the floor area where the puzzle-based storage system 10 is operating.

The figure shows a typical industrial robot arm that can be used for picking objects from and placing objects in the storage devices 15. How objects are picked from the storage devices 15 or placed in storage devices 15 depend on which solution that is preferred and the size of the puzzle-based storage system.

The picking system may also be installed as a stationary system operating on a floor area next to the puzzle-based storage system 10.

Prior to picking an object from a storage device 15 of placing an object in a storage device 15, the storage device 15 is made accessible for interaction by moving to predetermined or requested position. Content in open containers are accessible from above, while for a drawer system, a drawer must first be opened.

For storage devices 15 placed on a shelf-system, the picking system will be one that is adapted for first moving a storage device 15, e.g. a storage container, from a shelf before picking of a requested object from the storage container.

When a storage device 15 is a rotating shelf system, a specific storage container or drawer placed on a shelf can be accessed from the floor level even if a requested object is stored in the topmost shelf position. In this case the shelf with the requested object can be rotated while the transportation assembly 20 conveying the rotating shelf system is being moved to a requested position for picking the requested object. In this embodiment, the rotating shelf system comprises a receiver, controller, and circuitry for receiving rotation instruction.

FIG. 10 illustrates communication between autonomous rolling devices 40 of a transportation assembly 20 described above and a central controller unit 50, comprised in the puzzle-based storage system 10.

In the illustrated embodiment, the controller unit 50 controls movements of a transportation assembly 20 by transmitting control signals to each rolling device 40. Controlling movements of each rolling device 40 is feasible since each rolling device 40 comprises power means, driving means, communication means, and sensors for autonomously operation and controlled by the central controller unit 50. A rolling device 40 can rotate 360 degrees around its own axis, allowing it to drive in any direction. Furthermore, it can use input from the sensors and machine learning algorithms to sense the environment.

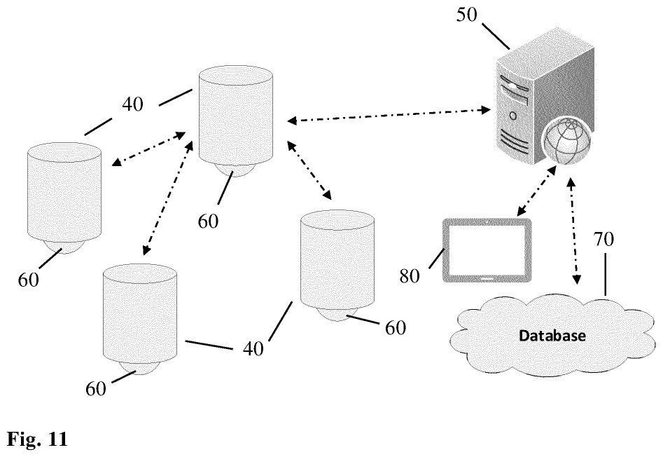

FIG. 11 illustrates another embodiment where communication is performed between the central controller unit 50 and only one of the autonomous rolling devices 40 of a transportation assembly 20.

In this embodiment, a specific autonomous rolling device 40 is a master device controlling the movements of the other rolling devices 40 connected to the transportation assembly 20 to be moved. The other rolling devices 40 will then act as slave devices and respond to instructions from the master device. The master device will then set up a specific moving pattern for the slave devices according to received control signals from the central control server 50 and transmit control signals to the slave devices, comprised in the same transportation assembly 20, instructing them to follow the movements of the master device. This configuration will significantly reduce the signal activity between rolling devices 40 and the central control unit 50.

Controlling of movements of each rolling device 40 can be done via a cloud computing system that can coordinate multiple rolling devices 40 comprised in transportation assembles 20. Suitable algorithms can be used for rearranging the transportation assemblies of the puzzle-based storage system within the floor area they are operating. Coordination of the transportation assemblies 20 can be performed by any suitable algorithm, e.g. by using Swarm intelligence where all the transportation assemblies 20 are treated as a system having collective behaviour with the environment, while interactions between the rolling devices 40 connected to same transportation body 30 of a transportation assembly 20 are coordinated and controlled.

Example of an autonomous rolling device 40 comprising driving and communication means as well power supply means is described in applicant's patent EP 3355148 B1, which is hereby included as a reference. Each rolling device 40 comprises a rolling element 60, e.g. a wheel located at the end of a housing of the rolling device 40, typically the lower end of the housing when in an installed position as connected to the transportation body 30 to be moved.

The central controller unit 50 comprises a computer program product and communication means for controlling movements of each rolling device 40 for arranging and re-arranging positions of each transportation assembly 20 in the set of transportation assemblies 20 in the two-dimensional compact puzzle-based configuration according to position information of each transportation body 30 stored in a database 70 connected to the central controller unit 50 and control commands transmitted to the rolling devices 40. The central controller unit 50 is further connected to a control device 80.

Various devices for controlling a rolling element 60 can be arranged in the housing of a rolling device 40, including wireless receiver and control electronics. The wireless receiver and the control electronics is signally connected to each other, and the receiver is arranged for receiving wireless control signals from the central controller unit 50.

Before moving a transportation assembly 20 in the two-dimensional compact puzzle-based configuration, its current position must be known. The current position may be its position relative to other transportation assemblies 20 in the puzzle-based configuration or its position relative to a floor area its being operating on.

There are different ways of detecting and acquiring the position of a rolling device 40, and thus the transportation assemblies 20 they are connected to. One way is by using internal means, e.g. motion detection sensors, installed in the rolling device 40. Another way is by using external means such as a camera 95 or by using Lidar for measuring the distance from a reference point to the rolling device 40. Another example is to use an RFID chip connected to the rolling device 40 or to the transportation assembly 20. Yet another way is by using ultrasound transmitter or a Bluetooth transmitter connected to the rolling device 40 for determining the position of the rolling device 40. Accurate position can then be found by means of triangulation.

Internal sensors and position detection devices keep track of the position of a rolling device 40 in the area it is operating in. Wheel encoders and inertial measurement units (IMU) can be used as motion detection sensors and odometry can be used for determining a current position based on generated data from the sensors.

Wheel encoders are used to detect rotation of the rolling element 60 enabling estimation of the distance travelled from a starting position. An IMU is used for estimating the orientation of the rolling device element and thus the direction/angle.

Odometry is used to estimate change in position over time based on the data generated from the wheel encoders and IMU sensors. In this way the current position of a rolling device 40 relative to a starting location can be estimated. The current position of the rolling device can be calculated by using a previously determined position, direction, and travelled distance. This is known as Dead Reckoning.

A more accurate method for determining the position of a rolling device 40 is achieved by combining said internal method with an external method for determining position. By combining data from various navigation systems having different physical principles one can increase the accuracy and robustness of the overall solution. By combining physical and mathematical methods, problems related to noise and drift can be alleviated. One may for instance combine Inertial Measurement Unit (IMU and wheel IMU) and Monocular Camera Simultaneous localization and mapping (SLAM).

For determining distance between rolling devices 40 of different transportation assemblies 20, Ultra-wideband (UWB) chip integrated in each rolling device 40 can be used. UWB is a radio technology requiring very low energy that is typically used for short-range communication. Signals from rolling devices 40 can be detected once they are for instance 12 cm from each other. The sensitivity of detection can be set and thus the accurate distance between rolling devices when detection occurs.

Combining sensor data derived from separate sources is known as Sensor Fusion, where the resulting data has less uncertainty than would be possible when the sources were used individually.

Since not all sensors are identical and further generate some noise, the noise and variances can be modeled, and the noise can be combined into a Kalman filter to reduce the noise and enhance the accuracy of odometry. In a first step, camera odometry and relative angle, i.e. travelling direction of the rolling device 40, are derived from IMU and then fused via Kalman filtering to get the best angle. At the same time, wheel encoders are fused together with wheel rotation given by wheel IMU to get the best translational distance driven. In a second step, the output from the two methods is fused to get a final filtered overall odometry resulting in a more precise determination of the position of a rolling device 40.

The database 70 connected to the central control server 50 can be a local database 70 installed in the central control server 50 or a remote located database 70 connected to the central control server 50 via the World Wide Web, i.e. a cloud computing system. The database 70 store position information for each transportation assembly 20 comprised in the storage system as well as identity of a connected storage devices 15. This information is accessed by the control server 50.

As an example, in a storage system comprising a total of 15 transportation assemblies 20 set up in a puzzle-based configuration of 4×4, each position occupied by a transportation assembly 20 within the 4×4 floor area is given x, y-coordinates, i.e. 1.1, 1.2, . . . 4.3, 4.4. Each transportation assembly 20 and is given a unique identity and position. This identity and position information is stored in the database 70 and used for rearranging transportation assemblies 20 according to movement instructions transmitted from the central controller device 50 to the rolling devices 40. The instructions may be in the form of a sequence listing the order the different transportation assemblies shall move and in which direction. The sequence will depend on a current position of a requested storage device 15 and the corresponding transportation assembly 20 as well as a determined delivery point. The request is typically initiated by an operator via a control device 80 communicating with the controller device 50.

Instructions transmitted to the rolling devices 40 from the central controller unit 50 can, as mentioned, be controlled from a control device 80, such as a PC or tablet communicating with the central control device 50.

The control device 80 runs software keeping track of the different storage devices 15, and which storage device 15 to be accessed at a delivery point can be controlled by input commands, e.g. by requesting access to a specific storage device 15.

A more complex system can keep track of which items that are stored in each storage device 15 and a user can search for and select an item to be retrieved. This requires that items stored in a storage device 15 are linked to the storage device 15 and/or its conveying transportation assembly 20, where this information is registered in a database.

When a specific storage device 15 or an item stored is requested by for instance by selecting it from a menu or from a visual presentation of the control device 80, the transportation assemblies 20 will rearrange positions until the requested storage device 15 is available at a defined delivery point, e.g. at an opening in a wall of a room adjacent to a room where the storage system 10 is installed.

Determining the present positions of the rolling devices 40 and thus the x, y-positions of the transportation assemblies 20, is vital for seamless re-arranging of positions of the transportation assemblies 20.

As mentioned above, there are different methods for determining positions of rolling devices 40. One way is by using a camera 95 installed above a storage system 10 as illustrated in FIG. 1. Movements and positions of each transportation assembly 20 can then be recorded and x, y position information can be deduced by video tracking software running in the central controller unit 50.

As mentioned, another way of determining position information of a transportation assembly 20 is to let internal means in the rolling device 40 determine its position and transmit it to the central control server 50 together with its unique identification. In this case the identity of rolling devices 40 connected to each identified transportation assembly 20 is registered in the database 70. From position information transmitted from the rolling devices 40, the central controller unit 50 will calculate x, y-positions.

As mentioned, the central controller unit 50 of the storage system 10 runs a computer program product that when executed controls movements of the autonomously operating rolling devices 40 connected to transportation bodies 30. Movements are controlled according to updated position information of the rolling devices 40 and input commands received from a control device 80, e.g. a tablet.

From the control device 80, the configuration of the storage system can be set up and monitored. When setting up the system, the number of operating transportation assemblies 20 is registered as well as the configuration of the storage system 10, e.g. the layout of a square or rectangle formation of a set of transportation assemblies 20.

Monitoring of a running puzzle-based storage system will include detection and warning of malfunctioning rolling devices 40 or low battery indication. Warning of low battery may denote that a specific battery, i.e. rolling device 40, must be replaced, or that the battery has not been sufficiently charged. The reason for this may be that there are not sufficient charging means 35 provided for the transportation assemblies, or that the puzzle-based storage system has been active for too long such that the rolling devices 40 have not been stationary at the charging zones for a sufficient amount of time.

The rechargeable power supply of the rolling devices 30 may as described be charged by powered tracks or wirelessly by for instance inductive means installed in the floor where the roller devices 40 are operating. Continuous charging of batteries is provided when the roller devices 40 are placed on powered tracks or on the inductive means.

A high capacity capacitor may operate as the rechargeable power supply of the autonomous rolling devices 40. This solution will buffer power to ensure that the driving and communication means is provided with continuous power supply for a period sufficient to move the autonomous rolling devices 40 from one charging zone to another. A combination of battery and high capacity capacitor is also feasible.

Batteries of autonomously operating autonomous rolling devices 40 may also be charged by letting a transportation assembly 20 leave a puzzle-based configuration to interact with a charging station nearby upon detection. Near field communication (NFC) can be used as means for detection. This may be implemented by NFC tape attached to the autonomous rolling devices 40. When the charging station detects the NFC tape, it will be activated and provide power for charging the autonomous rolling devices 40.

When setting up a puzzle-based storage system 10 described herein it can be done via the control device 80. If for instance fifteen transportation assemblies 20 with corresponding storage devices 15 are used in a 4×4 puzzle-based storage system, each transportation assembly 20 and their initial x, y positions are registered in a database 70. Pre-set configurations can be selected via a screen on the control device, or a specific configuration can be drawn on the screen by dragging and dropping symbols of transportation assemblies to specific positions.

The registering step includes registering IDs of transportation assemblies 20 and IDs of corresponding storage devices 15, as well as IDs of connected autonomous rolling devices 40 of each transportation assembly 20. When these parameters have been registered, the puzzle-base storage system is ready for operation.

Objects to be stored in the storage devices 15 can be registered and linked to a storage device 15 where it is stored via the control device 80.

When a specific object is to be retrieved from the puzzle-based storage system, the object can be selected via the control device 80. The system will know which storage device the item is stored in, and the corresponding transportation assembly carrying the storage device, as well as which autonomous rolling device 40 to send instructions to. The corresponding storage container where the requested object is stored, and the corresponding transportation assembly 20 will be retrieved from the database and requested to move to a specific x, y position of the puzzle-based storage system 10. If for instance a requested transportation assembly currently is located at x, y position 3, 3 in a 4×4 set-up, and the object is to be picked at x, y-position 1,1, the transportation assemblies 20 are shuffled and rearranged according to controlling algorithms until the requested storage device 15 has arrived at location 1,1 where the requested object can be picked up either manually or by a picking system 90.

The storage system 10 described herein is suited to be used in smaller installations, e.g. in a small storage room, in a garage, inside a truck etc. Due to its relatively simple construction, it is cost effective relative to similar prior art systems. It is further easy to replace separate rolling devices 40 if necessary. The storage system 10 can easily be moved to another location or reconfigured by adding or removing transportation assemblies 20. Different types and heights of storage devices 15 can be placed on the transportation assemblies 20, and the storage devices 15 can easily be changed and reconfigured according to requirements and physical restraints of the room where it is to operate.

1. A puzzle-based storage system to be operated on a floor area, comprising a set of separate transportation assemblies placed together in a two-dimensional puzzle-based configuration to occupy minimal floor area, where each transportation assembly comprises a rolling arrangement connected to a transportation body for moving the transportation assembly on the floor area, each transportation assembly is carrying and conveying a storage device, wherein
the rolling arrangement connected to each transportation body comprises at least four replaceable autonomous rolling devices, where each rolling device comprises a rolling element, driving means, sensors, controller, communication means, and a rechargeable power supply, and
where charging means providing power to the rechargeable power supply is provided on the floor area where the puzzle-based storage system is operating, and
where positions of each transportation assembly, within the floor area the puzzle-based storage system is operating, is controlled by a central controller unit comprising transmitting and receiving means and that is wirelessly connected to at least one of the replaceable autonomous rolling devices of each transportation assembly.

2. The puzzle-based storage system according to claim 1, further comprising interface elements mounted to each transportation body, the interface elements are adapted for receiving and connecting each rolling device to the transportation body.

3. The puzzle-based storage system according to claim 1, where a storage device is one or more containers, shelf systems, or a combination of these.

4. The puzzle-based storage system according to claim 3, where the storage device is a rotating shelf system.

5. The puzzle-based storage system according to claim 1, where the transportation body comprises connection means for securing the storage device to the transportation body.

6. The puzzle-based storage system according to claim 1, further comprising a control device connected to the central controller unit.

7. The puzzle-based storage system according to claim 1, where one of the autonomous rolling devices connected to a transportation body is operating as a master device and is wirelessly connected to the other autonomous rolling devices connected to same transportation body.

8. The puzzle-based storage system according to claim 1, where the charging means are charging tracks placed on the floor in areas according to footprints of the autonomous rolling devices.

9. The puzzle-based storage system according to claim 1, where the charging means is an inductive charging device placed in areas according to a footprint of each autonomous rolling devices of one or more transportation assemblies.

10. The puzzle-based storage system according to claim 9, where the inductive charging device is a charging mat with individually controllable inductive charging zones for each autonomous rolling device of one or more transportation assemblies.

11. The puzzle-based storage system according to claim 10, where each inductive charging zone comprises NFC device.

12. The puzzle-based storage system according to claim 1, further comprising an automated picking system for picking items from a requested storage device.

13. The puzzle-based storage system according to claim 12, where the automated picking system is placed within the floor area where the puzzle-based storage system is operating.

14. The puzzle-based storage system according to claim 12, where the automated picking system is placed on the outside of the floor area where the puzzle-based storage system is operating.

15. The puzzle-based storage system according to claim 13, where the automated picking system is placed on one of the transportation assemblies.

16. The puzzle-based storage system according to claim 14, where the picking system is movable along the border of the puzzle-based storage system and adapted for picking objects from the storage devices.

17. The puzzle-based storage system according to claim 1, where one or more cameras are connected to the central controller determining positions of each transportation assembly.

18. The puzzle-based storage system according to claim 17, where the one or more cameras are connected in the ceiling and directed at the storage devices for detecting identifications provided on the storage devices.

19. A method for providing a puzzle-based storage system to be operated on a floor area, by providing a set of transportation assemblies and placing the transportation assemblies together in a two-dimensional puzzle-based configuration to occupy minimal floor area, where each transportation assembly is provided by connecting a rolling arrangement to a transportation body of the transportation assembly for enabling moving the transportation assembly on the floor area, installing a storage device on each transportation assembly, characterized in further:
providing autonomy to each transportation assembly (20) by using at least four replaceable autonomous rolling devices as the rolling arrangement, where each replaceable autonomous rolling device comprises a rolling element, driving means, sensors, controller, communication means, and a rechargeable power supply,
providing charging means on the floor area where the puzzle-based storage system is operating for providing charging power to the rechargeable power supply,
providing a central controller unit with transmitting and receiving means and with a computer program product for controlling movements of each transportation assembly by transmitting control commands to at least one of the replaceable autonomous rolling devices according to received input instructions;
arranging and re-arranging positions of each transportation assembly in the set of transportation assemblies according to position information of each transportation body stored in a database connected to the central controller unit and control commands transmitted to the rolling devices.

20. A computer program product that when executed on a central controller unit controls movements of autonomously operating rolling devices connected to transportation bodies, together making transportation assemblies of a puzzle-based storage system, the transportation assemblies are arranged as a set of transportation assemblies in a two-dimensional compact puzzle-based configuration, and where movements of the rolling devices are controlled by the computer program according to position information stored in a database and input commands received from a control device.
